(19) United States
(12) Patent Application Publication
(10) Pub. No.: US 2012/0016544 A1
(43) Pub. Date: Jan. 19, 2012

(54) ELECTRIC VEHICLE ROLLOVER DETECTION SYSTEM AND METHOD

(75) Inventors: David Kevin Pariseau, Los Altos, CA (US); Yang Wang, Palo Alto, CA (US); Peng Zhou, El Cerrito, CA (US)

(73) Assignee: SINOELECTRIC POWERTRAIN CORPORATION, Sunnyvale, CA (US)

(21) Appl. No.: 12/938,047

(22) Filed: Nov. 2, 2010

Related U.S. Application Data
(60) Provisional application No. 61/364,313, filed on Jul. 14, 2010.

(51) Int. Cl. B60W 40/10; G06F 15/00; G01C 9/00; B60L 11/18

(52) U.S. Cl. 701/22; 702/150; 33/300

(57) ABSTRACT

An apparatus for detecting change in orientation comprises a first position sensor and a second position sensor. The position sensors are in different orientations. The outputs of the position sensors are filtered to smooth out instantaneous and/or insignificant changes in orientation, or noise. A processor or logic circuitry is configured to determine a change in both outputs, and communicate such a change. Furthermore, the processor or logic circuitry is configured to electrically and/or physically de-couple batteries from a power delivery system in an EV.

### CROSS-REFERENCE TO RELATED APPLICATIONS

This application claims priority to co-pending U.S. Provisional Patent Application Ser. No. 61/364,313, filed Jul. 14, 2010 and entitled “BATTERY MONITOR SYSTEM FOR AN ELECTRIC VEHICLE,” which is hereby incorporated by reference in its entirety as if set forth herein.

### FIELD OF THE INVENTION

The present invention relates to electrical power systems in electric vehicles. More specifically, the present invention relates to apparatus for and methods of determining and reacting to an electric vehicle rollover.

### BACKGROUND OF THE INVENTION

For a multitude of reasons, it is advantageous to use electric vehicles having rechargeable batteries rather than vehicles using internal combustion engines. Electric vehicles (EVs) are inherently more efficient, meaning more energy is used in locomotion than lost to heat than in conventional engines. Also, EVs do not exhaust any byproducts. However, the use of EVs presents technical challenges. For example, the batteries in an EV must be monitored with respect to rollover conditions. A rollover condition occurs when the battery becomes dislodged from its mounting point and freely moves about the cabin or other storage area or when the entire EV rolls over. In an EV having modular batteries, such as the EV and system described in U.S. patent application Ser. No. 12/779,877 to Zhou et. al., multiple batteries or battery packs must be monitored for a rollover condition. For safety reasons, a rollover condition must be detected, signaled and reacted to. Otherwise, first responders such as firefighters or paramedics may be injured by live batteries that have become damaged or are freely conducting current, or a host of other failure states that can be associated with a rollover. Also, in a rollover condition, a battery may cause a spark leading to fire. Signaling and reacting can include disconnecting the battery, emitting a rollover signal such as a sound, a light, or the like. Rollover monitoring and reaction systems in current vehicles are generally computer systems. Current solutions employ microprocessors executing an operating system. Such systems are inherently complex and require dedicated software systems that must be made sufficiently robust since a failure of the battery management system may cause the rollover monitoring and reaction system to fail.

### SUMMARY OF THE INVENTION

Cost effective, simple and modular methods and apparatus for detecting and reacting to an EV rollover are presented herein. As discussed above, operating systems and other software add cost that increase the retail prices of EVs to a point of commercial infeasibility. To that end, the methods and apparatus disclosed in this application are primarily hardware driven with off-the-shelf components that are widely available and do not depend on software. In operation, when there is a rollover event of the entire EV or the battery modules, a rollover detection device will detect the rollover condition and react to it accordingly. For example, when a rollover is detected, a rollover condition is signaled to a controller that disconnects the batteries from an overall power delivery system in an EV. Advantageously, any circuitry relating to the operation of the devices, modules and means described herein can be powered by the batteries that they are coupled to rather than a power bus that powers the remaining electrical system in an EV. As a result, the systems described herein can operate independently to electrically or physically de-couple batteries from a power delivery system in an EV even if a catastrophic event, such as a collision causing a tilt or rollover condition, has completely severed or destroyed the power delivery system.

In one aspect of the invention, an apparatus for detecting a change in orientation comprises a first and a second position sensor, outputting a first and a second tilt state respectively. The tilt state of each position sensor represents a tilt orientation that the apparatus is in. The apparatus also has a circuit for filtering a change in the tilt states should they occur, so that instantaneous changes in tilt orientation do not trigger a false rollover condition. Preferably, each of the position sensor are oriented opposite each other. Alternatively, the position sensors can be in other orientations other than directly opposite each other. When the apparatus is tilted, both position sensors will register the tilt. A controller registers the change in both tilt sensors after the filter. Preferably, the controller will output a tilt condition in response to a rollover. The controller is able to trigger a reaction to the rollover, such as disconnecting the batteries from the power delivery system of the EV.

In another aspect of the invention, a battery rollover detection system in an EV comprises at least one battery module coupled to a power delivery system, the battery module having a housing that encases a plurality of individual battery cells and a rollover detection circuit coupled to the housing, the rollover detection circuit. The rollover detection circuit comprises a first position sensor outputting a first state, a second position sensor outputting a second state, a circuit for filtering the first state and the second state, and a circuit for determining a difference between the first state and the second state. Furthermore, the first tilt sensor is in a first orientation, the second tilt sensor is in a second orientation, wherein the first orientation and second orientation are opposite one another. Alternatively, the orientations can be askew from each other rather than directly opposite. Preferably, the rollover detection circuit is coupled to the housing along a plane parallel to gravity and parallel to a top surface of the battery. Such a plane would be parallel to an approximate plane defined by the road that the EV is traveling on. Alternatively, the rollover detection circuit is coupled to the housing along a plane not parallel to the ground. In some embodiments, the rollover detection circuit further comprises a filter module for filtering a change of state from at least one of the first position sensor and the second position sensor and a circuit for determining a rollover condition based on a change of the first state and the second state relative to each other. Furthermore, the rollover detection circuit comprises a circuit for transmitting a rollover condition to an external controller and a circuit for disconnecting the at least one battery module from the power delivery system.

In another aspect of the invention, a method of detecting a rollover condition in a battery of a power delivery system of an EV comprises providing a first tilt sensor in a first orientation, providing a second position sensor in a second orientation, measuring a first state of the position sensor, measuring a second state of the second tilt sensor, and comparing the first state to the second state. In some embodiments, the method further comprises filtering at least one of the first state and the second state and signaling a rollover condition in response to the step of comparing the first state to the second state. Preferably, the method also comprises disconnecting the battery from the power delivery system in response to the step of signaling a rollover condition.

### BRIEF DESCRIPTION OF THE DRAWINGS

FIG. 1A shows an EV 100 having a modular battery pack 110.

FIG. 1B shows a tilt sensor per an embodiment of this invention.

FIG. 1C shows a tilt sensor per another embodiment of this invention.

FIG. 2A shows a modular battery having a tilt sensor mounted thereon per an embodiment of this invention.

FIG. 2B shows another modular battery having a tilt sensor mounted thereon per an embodiment of this invention.

FIG. 3 shows a method of detecting and reacting to a rollover per an embodiment of this invention.

### DETAILED DESCRIPTION OF THE INVENTION

In the following description, numerous details are set forth for purposes of explanation. However, one of ordinary skill in the art will realize that the invention can be practiced without the use of these specific details. Thus, the present invention is not intended to be limited to the embodiments shown but is to be accorded the widest scope consistent with the principles and features described herein or with equivalent alternatives. Reference will now be made in detail to implementations of the present invention as illustrated in the accompanying drawings. The same reference indicators will be used throughout the drawings and the following detailed description to refer to the same or like parts.

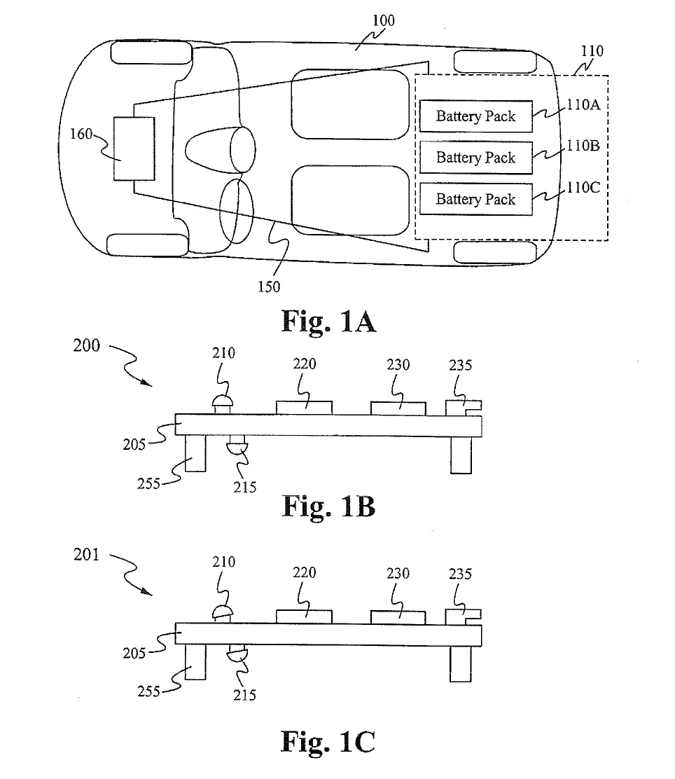

FIG. 1A shows an EV 100 having three modular batteries 110A, 110B and 110C in a modular battery compartment 110. As described in U.S. patent application Ser. No. 12/779,877, incorporated herein by reference, the use of modular batteries in an EV present a multitude of benefits, especially to the city dweller who does not have the option of plugging the EV 100 into an outlet. Modular batteries 110A, 110B and 110C allow the user to simply carry the batteries 110A, 11B and 110C to their apartment and charge them there. In general, the batteries 110A, 110B and 110C are electrically coupled to a power delivery system 150 that routes power to a powertrain, such as a motor 160. As described above, all EV systems have a means for detecting and reacting to rollover. However, the previous solutions are generally based on operating systems or are embedded into greater control and feedback systems that are costly and cumbersome.

To that end, a simple tilt sensor 200 is shown in FIG. 1B. In the exemplary embodiment shown, the tilt sensor 200 comprises a first position sensor 210 and a second position sensor 215 mounted to a substrate 205. The substrate 205 can be a printed circuit board, a bread board, or any other convenient means for coupling electrical components together. In some embodiments, the substrate 205 comprises mounting bosses 255 for affixing the tilt sensor 200 to a desired target, such as the modular batteries 110A, 110B and 110C of FIG. 1A. The first position sensor 210 and second position sensor 215 are disposed in opposite orientations. As a result, each position sensor will output an exactly opposite state. The first position sensor 210 will output a first state, and the second position sensor will output a second state. Assuming that ground is the bottom of the page, meaning that the first position sensor 215 is facing upward and the second position sensor 215 is facing downward, the first position sensor 210 outputs a non-tilted state. For the sake of convention, it will be assumed that the first position sensor 210 facing the sky and the second position sensor 215 facing the ground outputting a non tilt or rollover condition. Any other orientation will be defined as a tilt or rollover condition. Therefore, the orientation of the second position sensor 215 is a tilt or rollover condition.

The first position sensor 210 and the second position sensor 215 are coupled to logic circuitry 230. The logic circuitry 230 is configured to sense a change in both output states of the first position sensor 210 and the second position sensor 215. The logic circuitry 230 is further configured to determine a tilt condition when both the first position sensor 210 and the second position sensor 215 change states simultaneously. Since the tilt sensor 200 is mounted onto an object, such as a battery, when that object tilts, the tilt sensor 200 tilts along with it. As a result, both the first position sensor 210 and the second position sensor 215 changes orientation according to the tilt. The use of two oppositely oriented position sensors adds a layer of fault tolerance. Because the cost effective position sensors are generally mechanical devices, they are non-latching, meaning that once there is a change in their output state, that change to a new state is not latched and the output state can again change without being reset by an external control. Any errors caused as a result will not cause a faulty tilt or rollover condition because the logic circuitry 230 is configured to signal a tilt or rollover condition only upon a change in the output states of both position sensors; meaning that a faulty output from one position sensor will not be sufficient to cause a faulty tilt or rollover signal. Advantageously, the logic circuitry 230, which can be very simple and cost effective, will quickly be able to determine when output states of both position sensors change simultaneously. The logic circuitry 230 is coupled to an output port 235 for communicating a tilt condition to an external processor (not shown) that can then react to the tilt condition. In the example where the tilt sensor 200 is affixed to a modular battery in an EV, the external processor can shut down the battery, order a physical separation of the battery, or any other countermeasure for ensuring that passengers or safety personnel do not come into contact with live batteries in the event that an EV has rolled over during a collision. The logic circuitry 230 is preferably comprised of off the shelf integrated circuits. For example, a microprocessor, FPGA, ASIC or the like can be programmed to determine the difference in output states of the first and second position sensors. The person of ordinary skill having the benefit of this disclosure will readily identify several means and methods to realize the logic circuitry 230. In other embodiments, discrete analog components such as comparators and amplifiers can be used.

In some embodiments, it is advantageous to take into account momentary, insignificant changes in orientation to a battery in an EV. It is undesirable to determine a tilt condition when the condition is momentary. Doing so can cause the EV to stop receiving power and become stalled in traffic. To that end, a filter circuit 220 is included between the position sensors 210, 215 and the logic circuitry 230. The filter circuit 220 will smooth out the output signal of the position sensors 210 and 215, thereby filtering out momentary or instantaneous shifts in orientation that will naturally occur during driving, such as hitting potholes or going over driveways. Preferably, the filter circuit 220 comprises an active analog filter, generally available off the shelf, or a passive filter comprising at least two among a resistor, an inductor and a capacitor (e.g., an RC filter). The time constant of an RC filter can be set accordingly to filter out non events (known non-rollover conditions) of varying lengths. For example, an RC time constant can be tuned to filter out non events lasting under a second. Furthermore, non events, such as potholes or steep driveways, will cause small outputs from the position sensors 210 and 215, relative to a true rollover even which will cause the position sensors 210 and 215 to emit large outputs. Alternatively, digital filters or digital processing can be utilized, or any other known or convenient method of filtering a signal can be used. For example, the outputs of the position sensors 210 and 220 can be coupled to an analog to digital converter, and thereby the outputs can be filtered or otherwise manipulated digitally. In general, most off the shelf digital processors comprise analog to digital converters on board and thus digital implementations can be cost effective and simple. The person of ordinary skill having the benefit of this disclosure will readily identify several means and methods to realize the filter circuit 220. Furthermore, the time filter circuit 220 can be included in a single integrated circuit with the logic circuitry 230.

FIG. 1C shows an alternative embodiment. As a result of a collision or other traffic accident, it is possible that the EV does not come to rest upside down, but rather at an askew angle. For example, the EV may come to rest on its side, or any other angle given the chaotic nature of traffic collisions and accidents. As a result, the first position sensor 210 and second position sensor 215 may not come to rest at a sufficient angle relative to their starting point to output a change of state, and as a result the tilt sensor 200 will not detect a tilt condition. To that end, the first position sensor 210 and second acc215 are mounted to the tilt sensor 200 at an angle askew from the 205 as shown in FIG. 1C. In the embodiment of FIG. 1B, the tilt sensor 200 outputs a tilt state after rotating more than 90 degrees relative to a plane parallel to the ground. However, any angle by which the first position sensor 210 and the second position sensor 215 are offset relative to the substrate 205 will in turn offset the total rotation required for the tilt sensor 200 to output a tilt or rollover condition. For example, if the first position sensor 210 and second position sensor 215 are mounted to the substrate 205 at an angle of 30 degrees relative to the substrate 205, then the tilt sensor 200 will detect a tilt or rollover condition at 60 degrees rather than 90. Of course, this example assumes that the first position sensor 210 and second position sensor 215 are chosen such that they change their output state at 90 degrees. Preferably, the first position sensor 210 and the second position sensor 215 are oriented such that they register a different reaction and exhibit a different output to the same fault condition; i.e. a tilt or rollover condition. To that end, the orientation of the two position sensors can be directly opposite each other with respect to the substrate 205, or they can each be oriented with a positive angle with respect to the substrate 205, depending on the various position sensors that are selected based on application specific needs, and at what angle those specific position sensors exhibit a change in orientation. There are many different varieties of position sensors and other devices that can sense an angle relative to ground that can change their output state at an angle other than 90 degrees. However, such devices are generally more expensive and can require programming or additional components to realize. As a result, the solution proposed in this disclosure is especially advantageous for the building of safe, cost effective EVs.

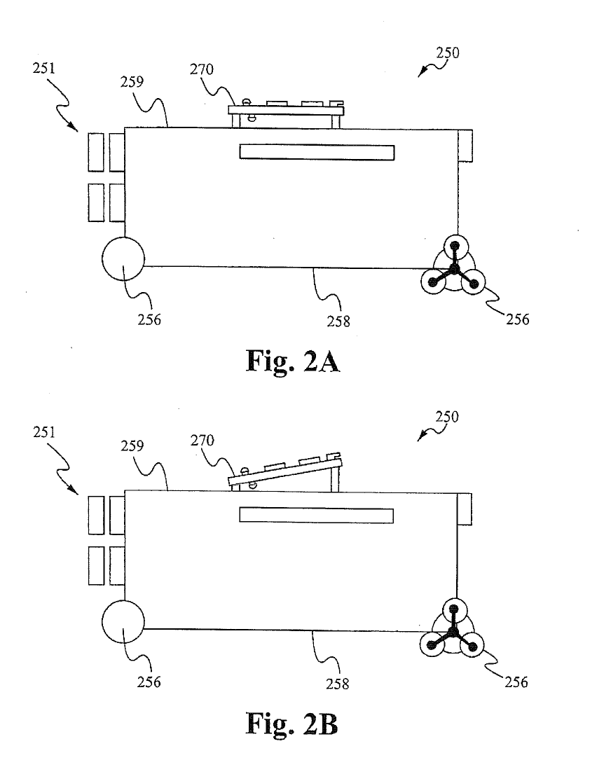

FIG. 2A shows a modular battery 250 having a tilt sensor 270 mounted thereon. In this example, the modular battery 250 comprises a set of wheels 256 for enhanced mobility. The modular battery 250 fits into a modular battery compartment (not shown) in a manner described in U.S. patent application Ser. No. 12/779,862; i.e. the bottom surface 258 faces the ground. In this example, the tilt sensor 270 is mounted on the top surface 259 along a plane substantially parallel to the top surface 259. The top surface 259 is also substantially parallel to the ground, accounting for manufacturing tolerances, variances in tire inflation, and other considerations. During a traffic accident, such as a collision or a solo rollover, either the battery 250 can become dislodged from its compartment (not shown), or the entire vehicle can come to rest on a side or top surface of the vehicle. As described above, it is imperative in such conditions that the battery 250 is able to detect the condition and to electrically and/or physically de couple from the power delivery system 150 shown in FIG. 1A. In the example of FIG. 2A, the tilt sensor 270 is electrically coupled to the modular battery 250 and physically mounted to the battery 250. Alternatively, the tilt sensor can be mounted within the battery 250. When a rollover or tilt condition is detected, a processor (not shown) internal to the modular battery 250 can electrically decouple the battery 250 from the power delivery system by disabling the mating connectors 251. Alternatively, a physical detachment can be achieved by the use of a mechanical switch such as a solenoid or relay that causes a physical separation between the battery 250 and the power delivery system 150 of FIG. 1. Other means and methods of physical or electrical de-coupling will be apparent to those of ordinary skill having the benefit of this disclosure.

FIG. 2B shows the tilt sensor 270 mounted to the battery 250 at an angle relative to the plane defined by the top surface 259 of the battery 250. The top surface 259 is also substantially parallel to the ground. In such a situation where either the battery 250 or the entire EV comes to rest on a side rather than a top surface, the resting angle of the tilt sensor 270 will be approximately 90 degrees. The resting angle can be such that neither the first position sensor 210 or the second position sensor 215 of FIG. 1B change states, and as a result a tilt or rollover condition is not detected. However, if the tilt sensor 270 is mounted at an angle, both the first position sensor 210 or the second position sensor 215 of FIG. 1B will change states because the tilt sensor 270 was already at an angle, and therefore if the EV comes to rest on its side, the tilt sensor 270 will come to rest at an angle greater than 90 degrees and causing both position sensors to change state, thereby causing the logic circuitry 230 of FIG. 1B to determine and signal a tilt or rollover condition. Although FIGS. 2A and 2B show the tilt sensor 270 mounted on the top surface 259 of the battery 250, the person of ordinary skill having the benefit of this disclosure will readily appreciate that the tilt sensor 270 can be mounted within the battery 250, on the battery compartment 110 of FIG. 1A, or any other convenient place where the tilt sensor 270 is able to determine a tilt or rollover condition and signal an external processor electrically decouple or physically disconnect the battery 250. Still alternatively, the tilt sensor 270 can be mounted flat relative to the top surface 259, but having position sensors mounted at an angle relative to each other as described in FIG. 1C.

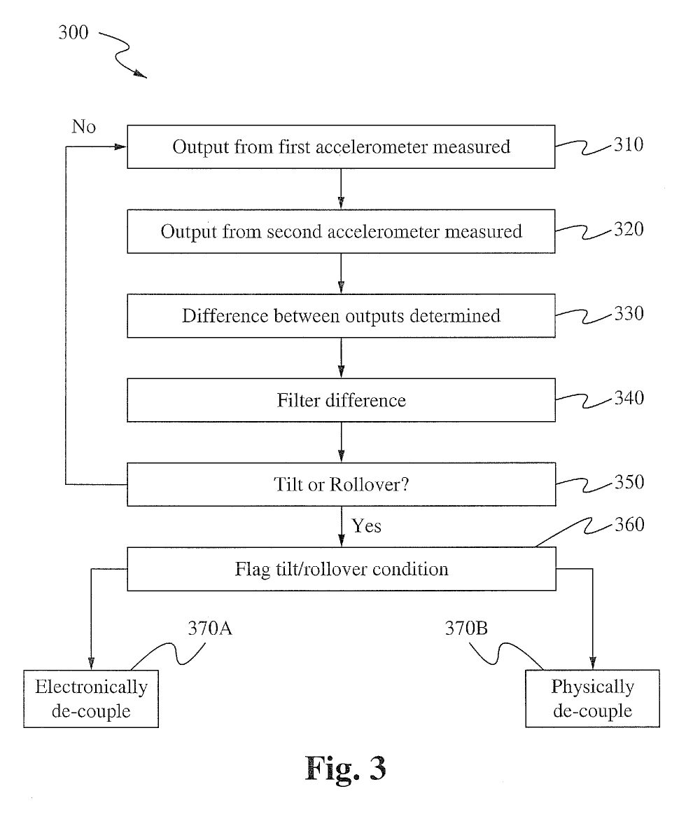

FIG. 3 shows a method 300 for determining and reacting to a tilt or rollover condition in an EV. In a first step 310, an output from a first position sensor is measured. In a second step 320, an output from a second position sensor is measured. The steps 310 and 320 can be done simultaneously and continuously. In a step 330, a difference between the first tilt sensor and the second tilt sensor is determined. In a step 340, the outputs of the first position sensor and second position sensor are filtered. This step serves to filter out instantaneous, momentary or insignificant changes in orientation that do not pose any safety risk. However, an unwanted reaction to an instantaneous, momentary or insignificant change in orientation can cause the EV to cease functioning if not filtered out. The step of filtering 340 can happen before or after the determination of a difference in the outputs in step 330. In a step 350, a tilt or rollover condition is determined if both the outputs of the first position sensor and second position sensor have a persistent change. As described above, the difference between the first tilt sensor and second tilt sensor can be used to determine a tilt or rollover condition. In a step 360, a tilt or rollover condition is flagged and communicated to a processor. The processor can be on board a tilt sensor or the battery, or any other convenient location. Preferably, the tilt or rollover condition is reacted to. In a step 370A, a battery is electrically de-coupled from a power delivery system in an EV, and in a step 370B, the battery is physically de-coupled from a power delivery system in an EV.

A person of ordinary skill having the benefit of this disclosure will readily appreciate the benefits. What is provided is a cost effective, easily deployable system for detecting and reacting to a tilt or rollover condition in an EV without the use of operating systems, software, or firmware. As a result, the systems and methods described above can operate independent of any computer system or other network that is employed within an EV. Advantageously, should those other systems fail during a collision or other traffic accident or any other rollover or tilt condition, the tilt or rollover condition will still operate and as a result the batteries of the EV will be physically and/or electrically de-coupled from the rest of a power delivery system. Used herein, the term “position sensor” is not meant to be limiting but rather encompasses a broad spectrum of modules, assemblies and components that sense an orientation and output a state based on that orientation, including but not limited to various accelerometers, capacitive devices, piezoelectric devices, MEMS devices, spring mass base devices, electromechanical devices, quartz devices, shear mode devices, thermal devices, or any other known, convenient or application specific modules that sense and output an orientation.

While the invention has been described with reference to numerous specific details, one of ordinary skill in the art will recognize that the invention can be embodied in other specific forms without departing from the spirit and scope of the invention as defined by the appended claims. Thus, one of ordinary skill in the art will understand that the invention is not to be limited by the foregoing illustrative details.

What is claimed is:

1. An apparatus for detecting a change in orientation comprising:
a. a first position sensor in a first orientation outputting a first state;
b. a second position sensor in a second orientation outputting a second state;
c. a circuit for filtering the first state and the second state; and
d. a circuit for determining a change in both the first state and the second state.

2. The apparatus of claim 1 wherein the first orientation and second orientation are opposite each other.

3. The apparatus of claim 1 further comprising a circuit for outputting a tilt condition.

4. The apparatus of claim 1 wherein a tilt condition is determined by a change in both the first state and the second state.

5. The apparatus of claim 1 wherein the circuit for filtering the first state and the second state comprises any among an RC filter, and RL filter, an LC filter, and an RLC filter.

6. The apparatus of claim 1 wherein the circuit for filtering the first state and the second state comprises a processor.

7. The apparatus of claim 1 wherein circuit for determining a change in both the first state and the second state comprises a processor.

8. The apparatus of claim 1 wherein circuit for determining a change in both the first state and the second state comprises logic circuitry.

9. The apparatus of claim 1 wherein the first position sensor changes the first state at a predetermined angle relative to a plane parallel to the ground.

10. The apparatus of claim 1 wherein the second position sensor changes the second state at a predetermined angle relative to a plane on which the apparatus sits.

11. The apparatus of claim 1 wherein the first position sensor comprises a first tilt threshold, the second tilt sensor comprises a second position sensor, and the first and second tilt thresholds are the same.

12. The apparatus of claim 1 wherein the first position sensor comprises a first tilt threshold, the second tilt sensor comprises a position sensor tilt threshold, and the first and second tilt thresholds are the not same.

13. In an electric vehicle, a battery rollover detection system comprising:
a. at least one battery module coupled to a power delivery system, the battery module having a housing that encases a plurality of individual battery cells;
b. a rollover detection circuit coupled to the housing, the rollover detection circuit comprising:
i. a first position sensor outputting a first state;
ii. a second position sensor outputting a second state;
iii. a circuit for filtering the first state and the second state; and
iv. a circuit for determining a change in both the first state and the second state.

14. The battery rollover detection system of claim 13 wherein the first position sensor is in a first orientation, the second position sensor is in a second orientation, wherein the first orientation and second orientation are opposite one another.

15. The battery rollover detection system of claim 13 wherein the first position sensor is in a first orientation, the second position sensor is in a second orientation, wherein the first orientation and second orientation are askew from another.

16. The battery rollover detection system of claim 13 wherein the rollover detection circuit is coupled to the housing along a plane parallel to ground.

17. The battery rollover detection system of claim 13 wherein the rollover detection circuit is coupled to the housing along a plane not parallel to ground.

18. The battery rollover detection system of claim 13 wherein the rollover detection circuit further comprises a filter module for filtering a persistent change of state from at least one of the first position sensor and the second position sensor.

19. The battery rollover detection system of claim 13 wherein the rollover detection circuit comprises a circuit for determining a rollover condition based on a change of the first state and the second state relative to each other.

20. The battery rollover detection system of claim 13 wherein the rollover detection circuit comprises a circuit for transmitting a rollover condition to an external controller.

21. The battery rollover detection system of claim 13 wherein the rollover detection circuit comprises a circuit for disconnecting the at least one battery module from the power delivery system.

22. In a power delivery system of an electric vehicle, a method of detecting a rollover condition in a battery comprising:
a. measuring an output of a first position sensor in a first orientation;
b. measuring an output of a second position sensor in a second orientation, different than the first orientation; and
c. comparing the outputs of the first and the second position sensor.

23. The method of claim 22 further comprising filtering at least one of the first state and the second state.

24. The method of claim 22 further comprising signaling a rollover condition in response to the step of comparing the first state to the second state.

25. The method of claim 22 further comprising disconnecting the battery from the power delivery system in response to the step of signaling a rollover condition.
